(19) United States
(12) Patent Application Publication
(10) Pub. No.: US 2013/0246231 A1
(43) Pub. Date: Sep. 19, 2013

(54) FINANCIAL DIMENSION DEFAULT TEMPLATES

(71) Applicants: Kristi M. Weekley, Lake Park, MN (US); Changju Lee, Bellevue, WA (US)

(72) Inventors: Kristi M. Weekley, Lake Park, MN (US); Changju Lee, Bellevue, WA (US)

(73) Assignee: MICROSOFT CORPORATION, Redmond, WA (US)

(21) Appl. No.: 13/424,362

(22) Filed: Mar. 19, 2012

(51) Int. Cl. G06Q 40/00

(52) U.S. Cl. 705/30

(57) ABSTRACT

An allocation template is generated by indicating which financial dimensions are to be allocated an amount reflected in a source document, along with the proportionate share of the amount that is to be allocated to each of the financial dimensions. The allocation template is then assigned to a source document (either to the document as a whole, or to individual lines of the document) so the amount in the source document is automatically allocated as indicated by the allocation template.

### BACKGROUND

There are a wide variety of different types of business applications that are currently available that generate business documents. For instance, some enterprise resource planning (ERP) systems and customer relations management (CRM) systems, among others, generate purchase order documents that reflect purchases made by an organization. In addition, they often generate sales order documents that represent sales made by the organization. Other documents are also generated that reflect expenses paid by the organization, or revenues received by the organization.

It is also quite common that, in current systems, the amounts reflected in the documents must be allocated among several different entities. These entities are referred to as financial dimensions. For instance, when a purchase order document is being processed, the amount of the purchase may be allocated back to different business units.

By way of example, it may be that a particular business requires a fleet of vehicles, and the vehicles are used by both sales personnel and service personnel. Therefore, a purchase order of a vehicle for $1000 may be processed such that half of the $1000 is allocated to the sales department and half is allocated to the service department. In the past, this type of allocation has been performed by manually splitting the amount across the various financial dimensions. This can be very cumbersome and time consuming, and it can also be quite error prone.

The problem is also exacerbated by the many different types of financial documents that are currently used. For instance, some financial documents include a plurality of different lines, each reflecting a different amount of an expense or revenue. In some cases, each line must be manually split among various financial dimensions. This makes the problems associated with the manual process even worse. Similarly, in certain scenarios, the same split percentage is repeatedly used. For instance, recurring transactions, such as rent or insurance payments, require these expenses to be split, manually, each month. This is cumbersome and labor intensive.

The discussion above is merely provided for general background information and is not intended to be used as an aid in determining the scope of the claimed subject matter.

### SUMMARY

An allocation template is generated by indicating which financial dimensions are to be allocated an amount reflected in a source document, along with the proportionate share of the amount that is to be allocated to each of the financial dimensions. The allocation template is then assigned to a source document (either to the document as a whole, or to individual lines of the document) so the amount in the source document is automatically allocated as indicated by the allocation template.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative business systems.

FIG. 2 is a flow diagram illustrating one embodiment of the operation of the system shown in FIG. 1 in generating an allocation template.

FIGS. 2A-2D show exemplary embodiments of user interface displays which can be used in generating an allocation template.

FIG. 3 is a flow diagram illustrating the assignment of an allocation template to a source document.

FIGS. 3A-1 to 3G show examples of user interface displays that can be used in assigning one or more allocation templates to a source document, in various embodiments.

FIG. 4 illustrates one embodiment of the system shown in FIG. 1 in a cloud computing architecture.

FIGS. 5-9 illustrate various embodiments of mobile devices.

FIG. 10 shows one embodiment of an illustrative computing environment.

### DETAILED DESCRIPTION

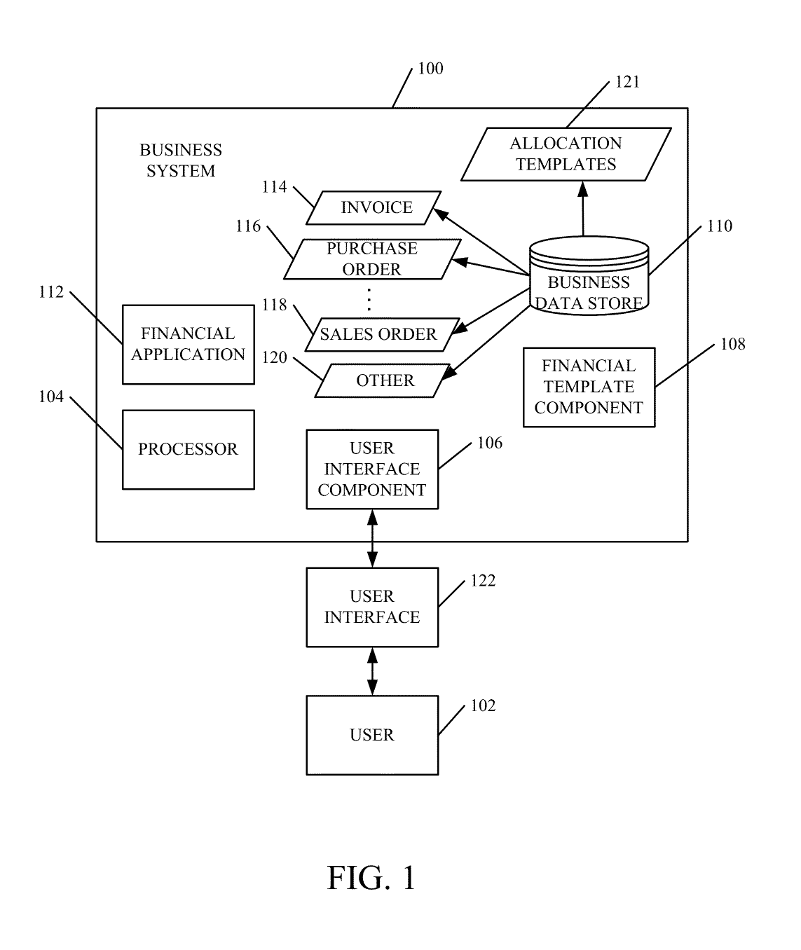

FIG. 1 is a block diagram of one illustrative embodiment of a business system 100 that user 102 interacts with in order to conduct business. In one embodiment, business system 100 includes processor 104, user interface component 106, financial template component 108, data store 110 and financial application 112. In the embodiment discussed herein, financial application 112 is an enterprise resource planning (ERP) or customer resource management (CRM) application that includes financial components that generate, or handle, source documents that reflect financial amounts. The source documents can reflect revenues to the company or expenses to the company, or they can reflect any financial amounts which impact the company, in various transactions. Some examples of source documents include invoices 114, purchase orders 116, sales orders 118, and other documents 120.

In one embodiment, the documents operated on by financial application 112 are stored in business data store 110. In the embodiment shown in FIG. 1, data store 110 is shown as part of business system 100, although it will also be appreciated that data store 110 can be located remotely as well.

Processor 104 is illustratively a computer processor with associated timing and memory circuitry (not shown). Processor 104 is also illustratively a functional component of system 100 and is activated by, and facilitates the functionality of, other components or applications in system 100. Processor 104 uses user interface component 106 to generate user interfaces 122 for user 102. A user interface 122 illustratively includes a display with user input mechanisms which allow user 102 to interact with system 100, and particularly financial application 112. The user interface 122 can include mechanisms that receive voice commands, touch gestures, inputs from a point and click device or a keyboard, or any of a wide variety of other user inputs.

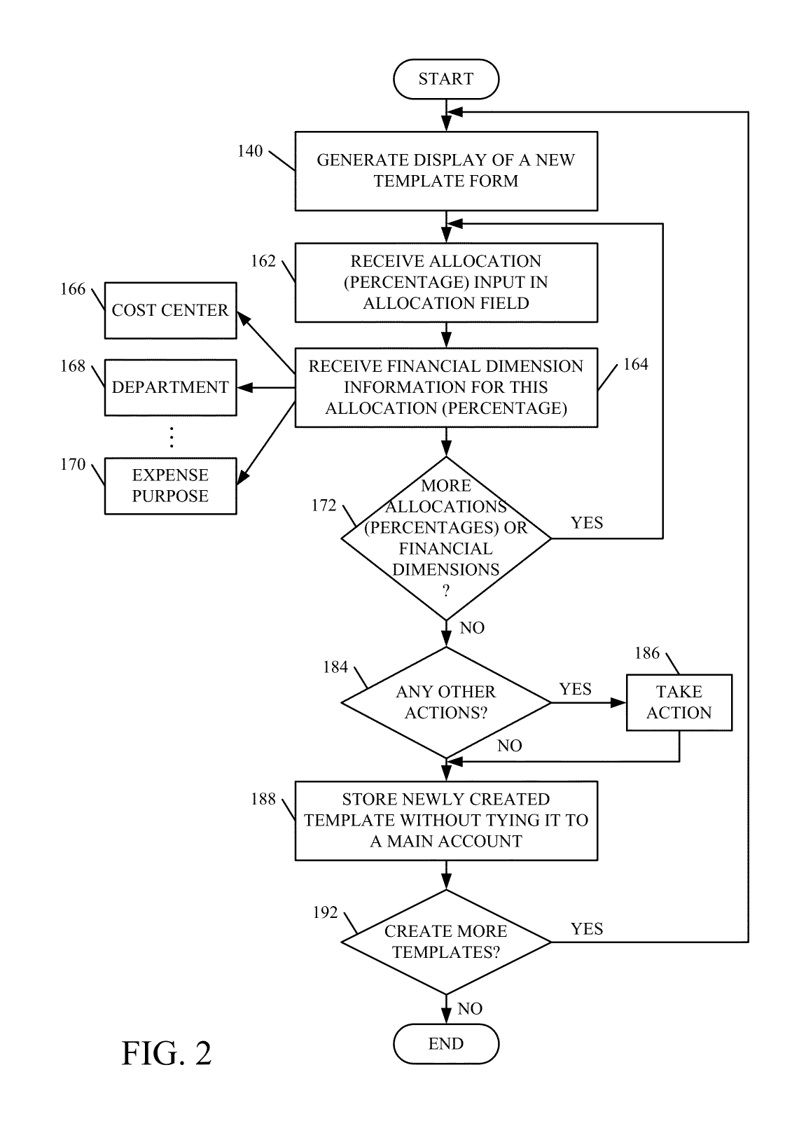

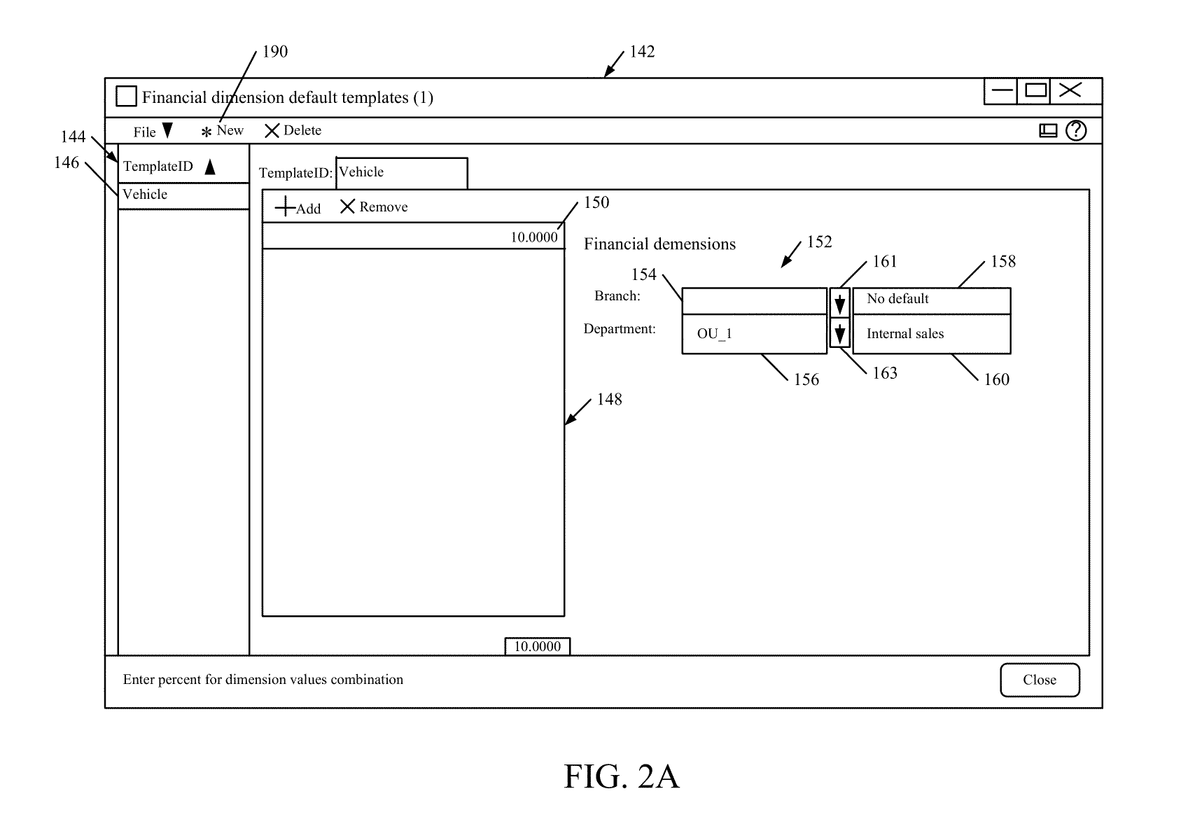

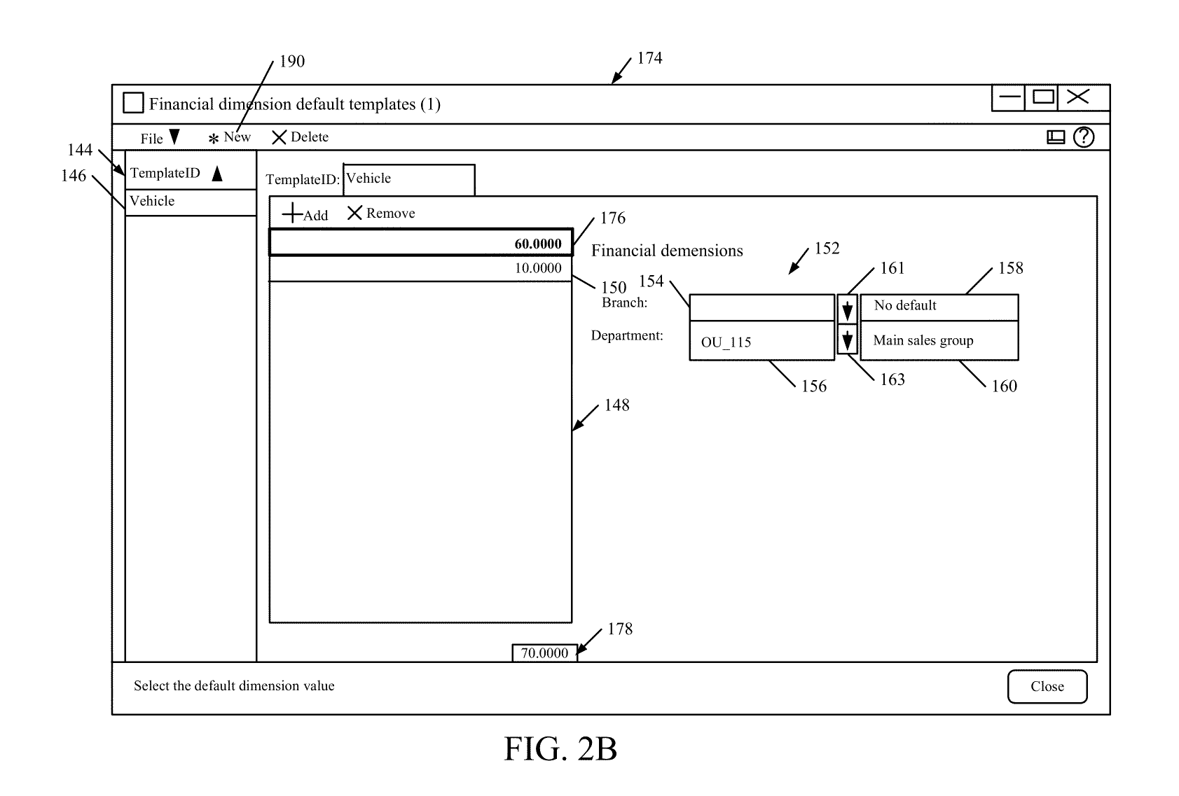

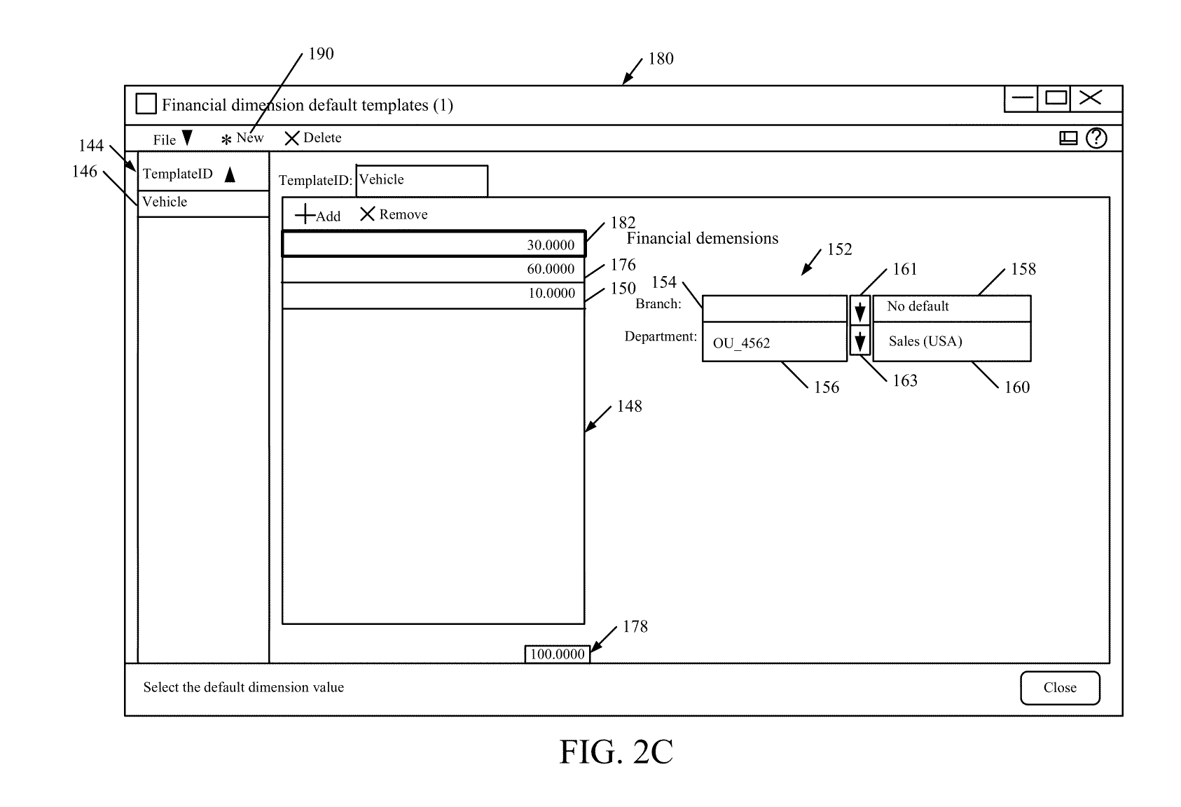

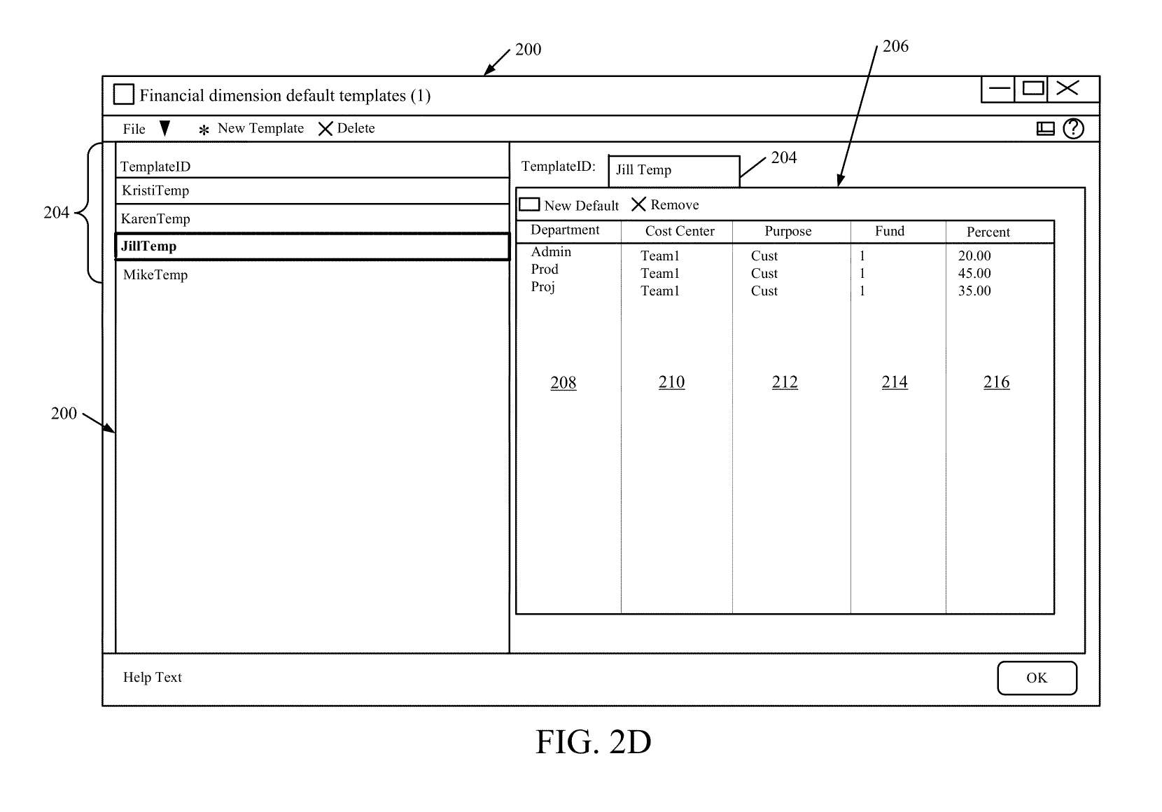

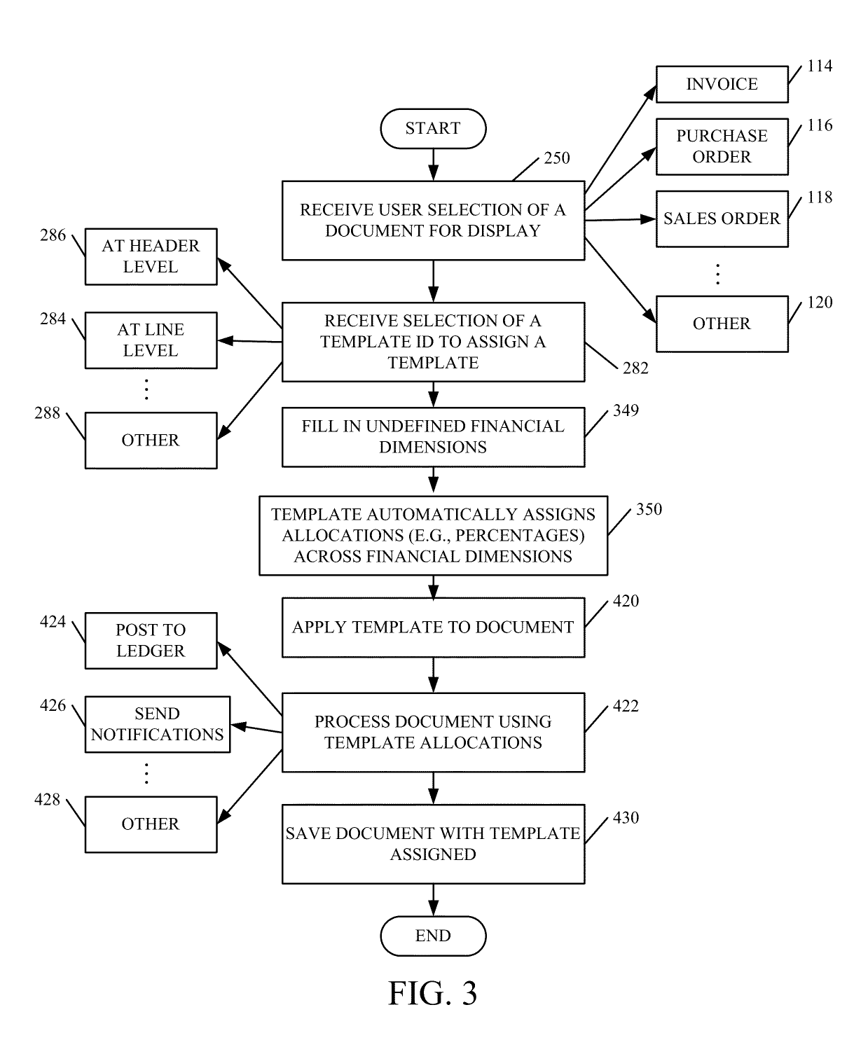

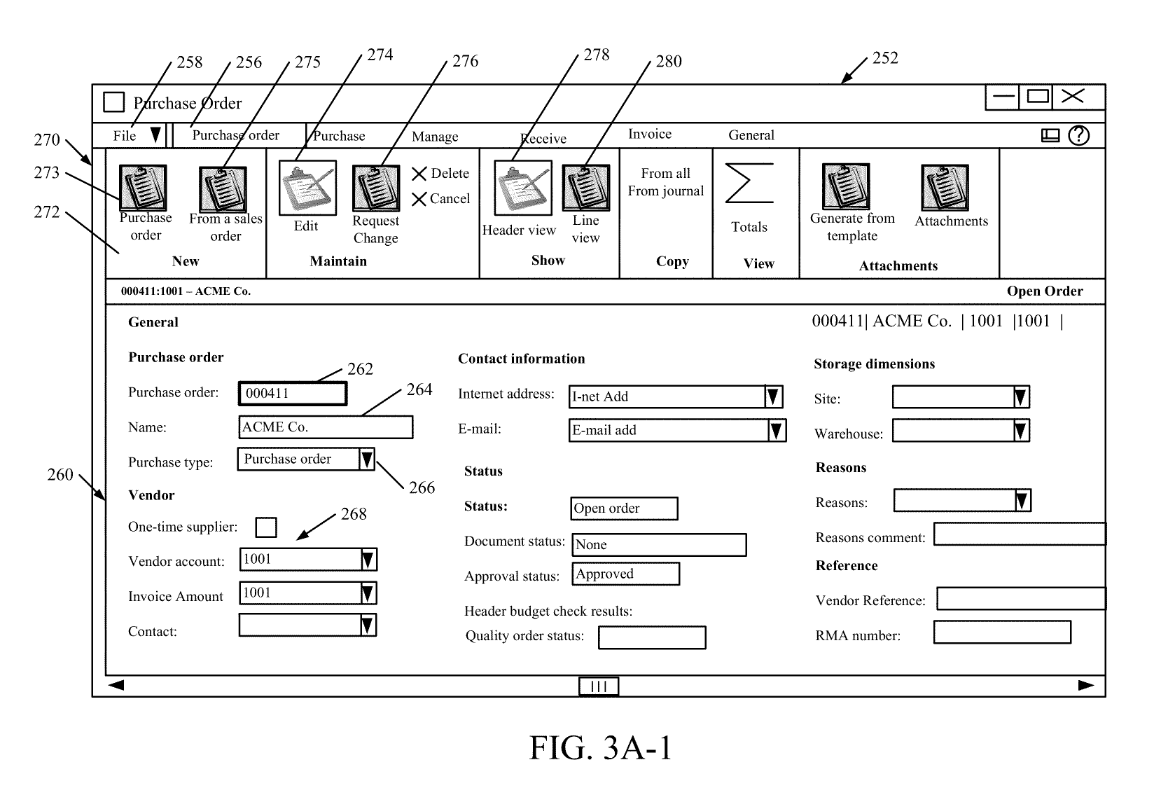

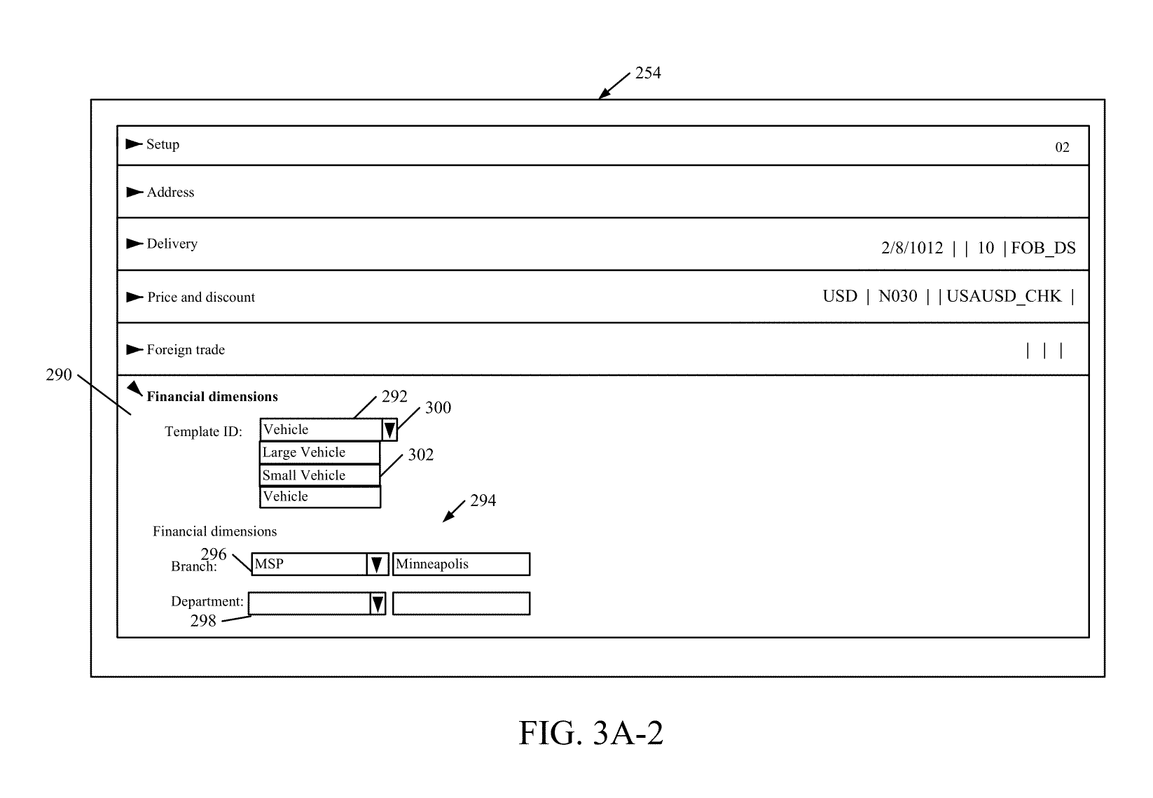

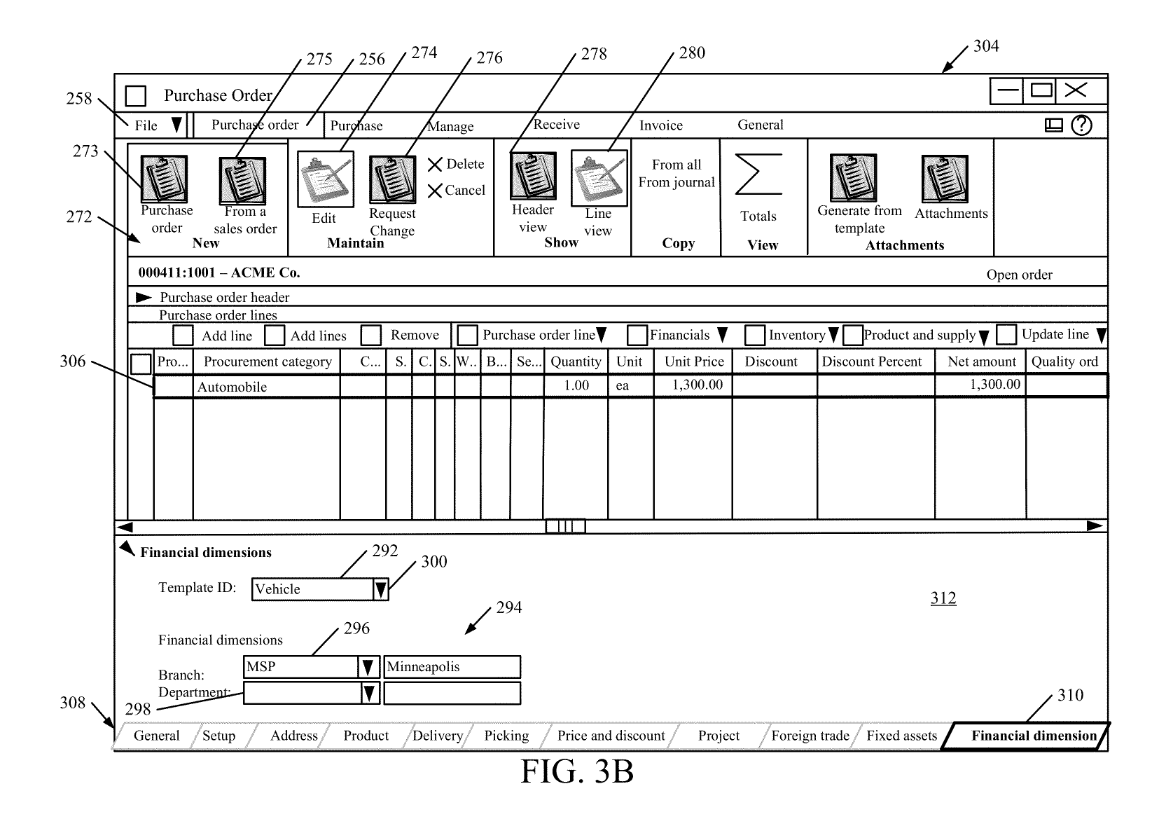

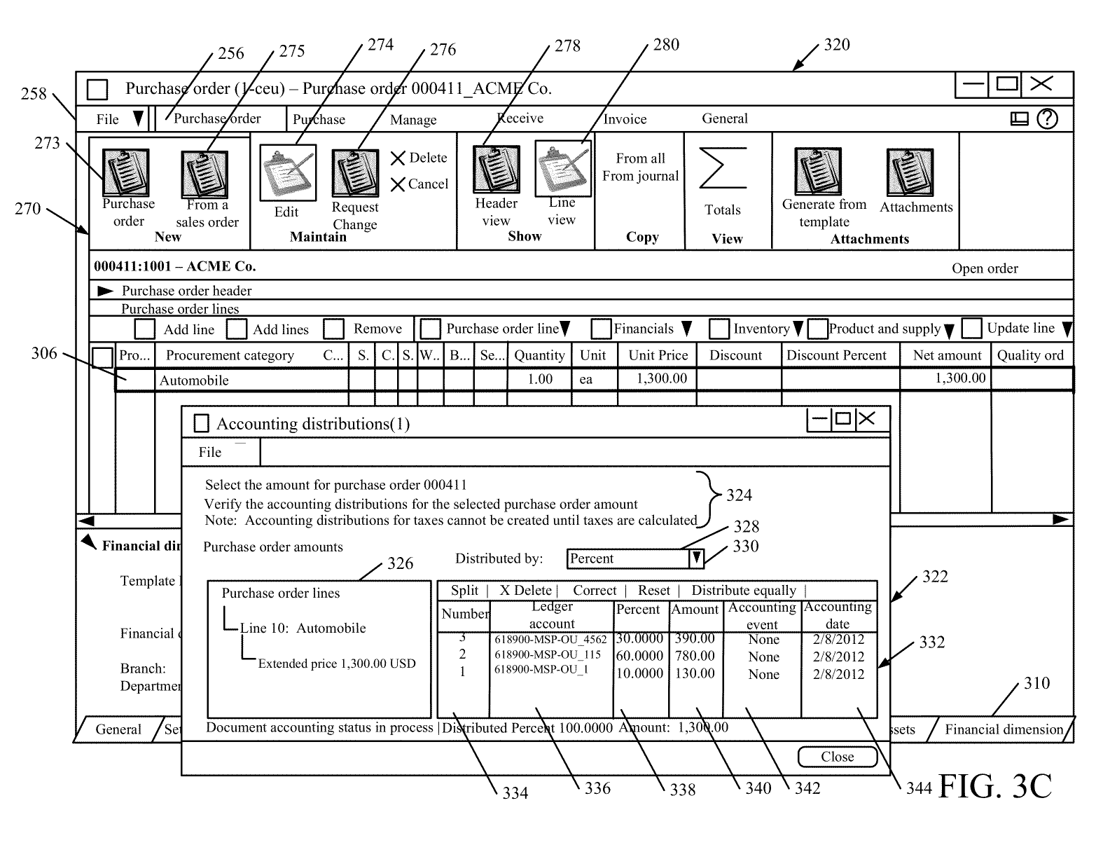

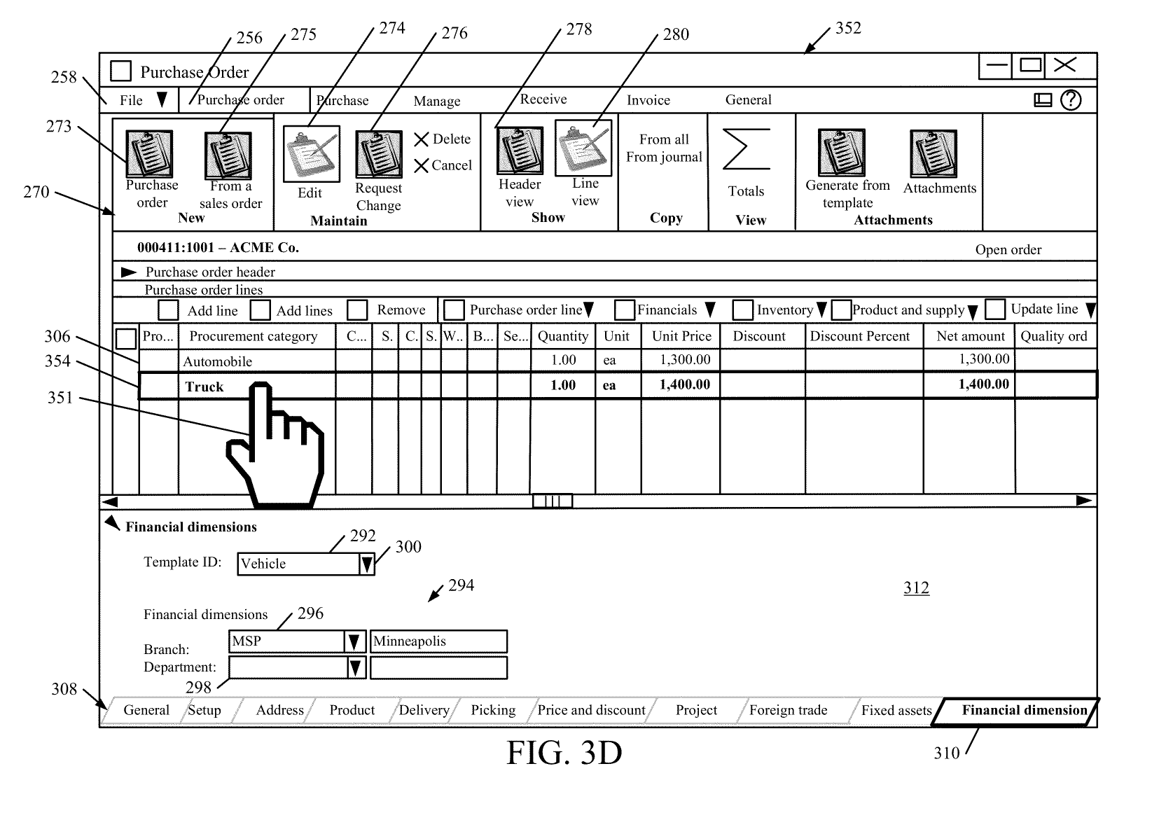

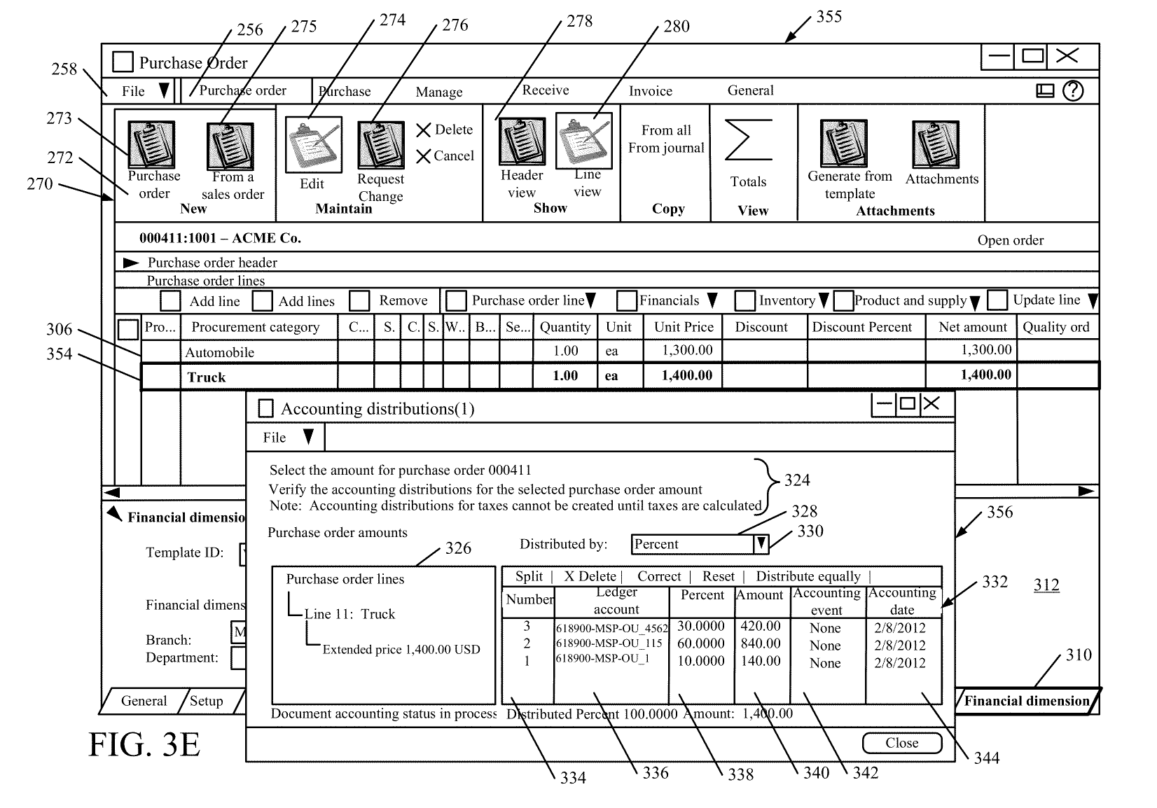

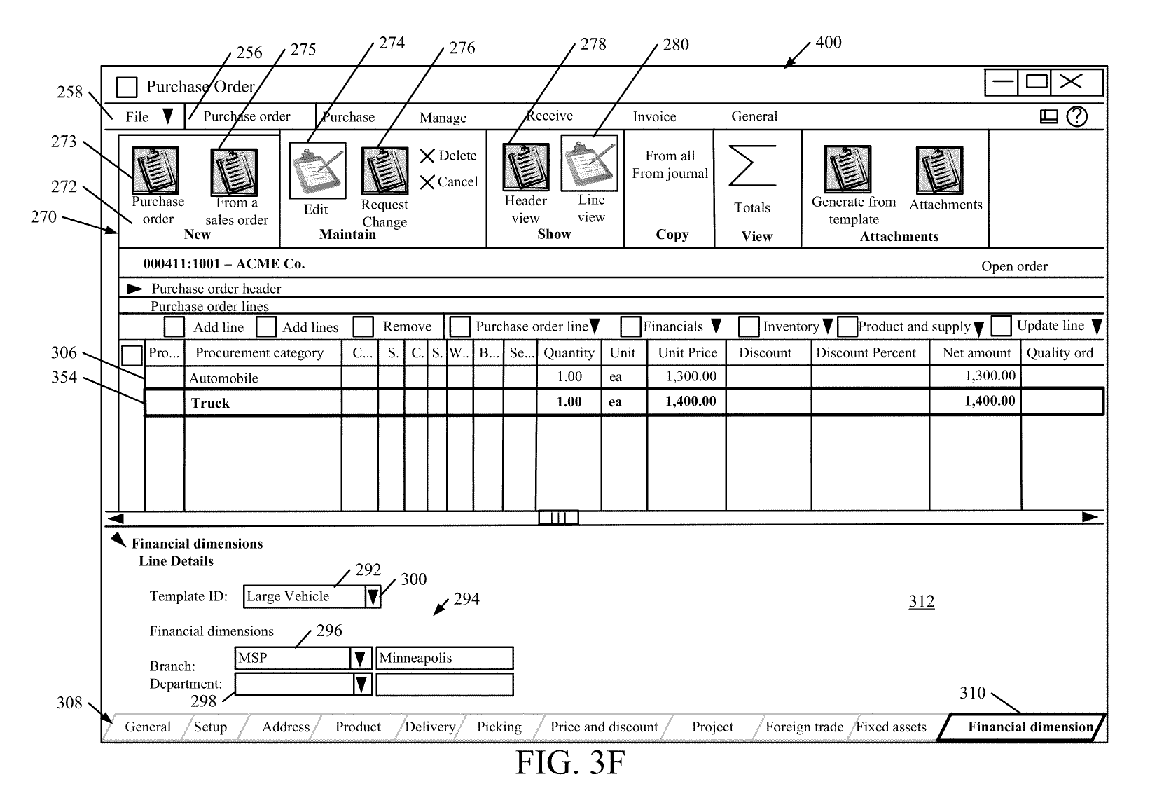

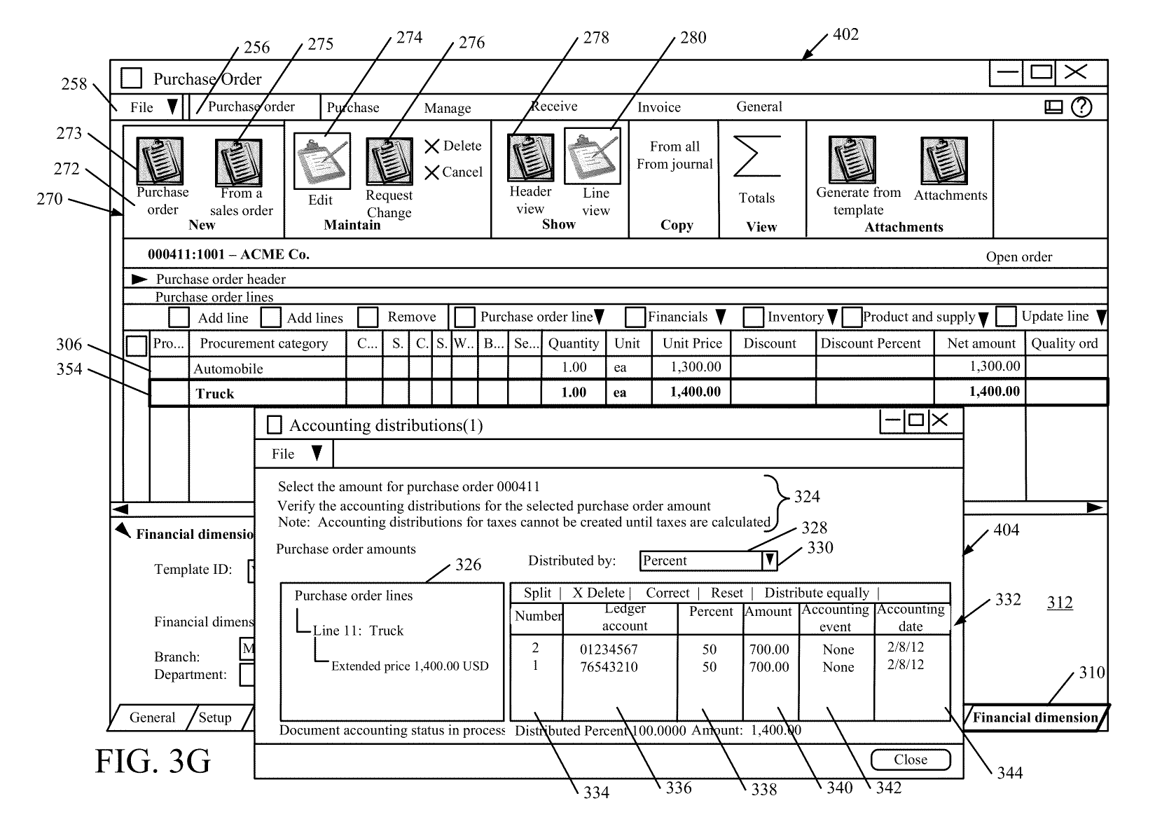

The operation of system 100 is shown in greater detail with respect to FIGS. 2-3G below. Briefly, however, user 102 illustratively uses financial template component 108 to generate allocation templates 121 which can be stored (such as in store 110) and applied to source documents in data store 110, that are operated on by financial application 112. User 102 illustratively first generates the allocation templates 121 and stores them in business store 110. User 102 then illustratively assigns the allocation templates 121 to the source documents. As discussed below, user 102 can assign a given allocation template 121 to a source document, as a whole, by assigning it the source document's header. In another embodiment, the user can assign different templates to individual lines of the source document as well. Then, when financial application 112 operates on the source document, with the assigned allocation templates, application 112 allocates the amounts in the source document as indicated by the assigned allocation template.

FIG. 2 is a flow diagram illustrating the operation of system 100 in generating an allocation template 121 that can later be assigned to one or more source documents. In one embodiment, user interface component 106 first receives a user input through user interface 122 that indicates that user 102 wishes to generate an allocation template 121. In response, financial template component 108 illustratively generates a display of a new template form. This is indicated by block 140 in FIG. 2. FIG. 2A shows one illustrative example of a user interface display 142 that shows a new template form. User interface display 142 illustratively includes a template ID section 144 that lists various template identifiers for allocation templates 121 that can be generated. In the embodiment shown in FIG. 2A, one of the template identifiers is the Vehicle template ID 146. The user has illustratively typed in the template ID “Vehicle” as Vehicle template ID 146 or the user may have chosen it from a drop down menu or input it in a different way.

Once the user has input a name for the template ID, the user illustratively provides allocations in allocation field 148. In the embodiment discussed herein, the user 102 inputs allocations that identify a percentage of the amount reflected in a source document that is to be allocated to a given financial dimension. For instance, in the embodiment shown in FIG. 2A, allocation field 148 includes the number 10.0000 shown generally at 150. This indicates that the user has indicated that 10 percent of the amount reflected in a source document to which this allocation template is assigned is to be allocated to the financial dimensions set out in the financial dimension identifier fields 152. In the embodiment shown, the financial dimensions that can be identified are a “Branch” financial dimension that can be input in field 154 and a “Department” financial field which can be input in field 156. In one embodiment, where no financial dimensions are input into fields 154 or 156, the financial dimensions will illustratively be default financial dimensions that are identified in corresponding fields 158 and 160.

In any case, once user interface display 142 is displayed and shows a new allocation template form, financial template component 108 receives, though the user interface display 142, allocations input in allocation field 148. As indicated, above, in the embodiment shown in FIG. 2A, the user 102 can input allocations as percentages. Thus, FIG. 2A shows that the user has input a 10 percent allocation at 150. Receiving the allocation input is indicated by block 162 in FIG. 2.

Once the percentage has been input, financial template component 108 receives a user input that identifies the particular financial dimension that is to receive the allocation. That is, in the embodiment in FIG. 2A, the user has input department OU_{—}1 in financial dimension field 156. This indicates that, according the template shown in FIG. 2A, the ledger account labeled “OU_{—}1” is to receive a 10 percent allocation whenever this particular template is applied to a source document. Receiving the financial dimension information for this particular allocation is indicated by block 164 in FIG. 2A. It will be noted that, while the financial dimensions shown in FIG. 2A include a “branch” and a “department”, the financial dimensions could be substantially any entity or dimension that the business wishes to receive allocations of expenses, revenues or other amounts. Some examples include cost centers 166, departments 168, expense purpose entities 170, etc.

User interface display 142 also shows that, instead of simply typing into fields 154 and 156, the user can select the financial dimensions from a drop down menu, or in any other desired way. For instance, when the user actuates the drop down menu button 161, a drop down menu is illustratively displayed which shows various branches that can be assigned the given allocation amount. By selecting one of the branches from the drop down menu, fields 154 and 158 will automatically be populated. Similarly, the user can illustratively actuate drop down menu button 163 to select (from a drop down menu) a specific department. When the user selects a department from the drop down menu, fields 156 and 160 are illustratively automatically populated.

It should also be noted that, while the present description has proceeded with respect to the user first inputting the percentage and then the financial dimension, these steps could be performed in reverse as well. That is, the user could first input the information identifying the financial dimension, and then input the particular allocation value.

In any case, once the user has input an allocation value and identified a financial dimension that is to receive that allocation value, it is then determined whether there are more allocations or financial dimensions which must be input using this template. This is indicated by block 172 in FIG. 2. In one embodiment, it is assumed that a given allocation template will allocate 100 percent of an amount to which the allocation template is assigned. Therefore, when the allocation values are given in terms of percentage, then the values in allocation field 148 will add up to 100 percent. In other embodiments, the percent allocated does not need to add up to 100 percent. Instead, the value in the allocation field is less than or equal to 100 percent and if the total ends up less than 100 percent, the remaining amount is automatically allocated to a default dimension for the source document or for the individual line. It can be seen from FIG. 2A that the total allocations made with respect to this allocation template only account for 10 percent. Therefore, in one embodiment, there are more allocations to be input by the user and processing reverts to block 162.

FIG. 2B shows another user interface display 174. Display 174 is similar to display 142, and similar items are similarly numbered. However, it can be seen that the user has now input an additional allocation amount of 60 percent into field 148. The 60 percent allocation amount is indicated in field 176. It can also be seen that the user has input financial dimension information by assigning the 60 percent allocation to the ledger account “OU_{—}115” which is the “main sales group”. This information is indicated in fields 156 and 160, respectively.

Financial template component 108 then again arrives at block 172 in FIG. 2 and determines whether there are more allocations or financial dimensions to be input for this template. It can be seen from FIG. 2B that the total percent of the allocations made in this template are shown by total allocation indicator 178, and only 70 percent of the amount has been allocated. Therefore, in the embodiment where the allocation amounts are to equal 100 percent, there are additional allocations to be made and processing again reverts to block 162 in FIG. 2.

FIG. 2C shows another user interface display 180. User interface display 180 is similar to user interface display 174 shown in FIG. 2B, and similar items are similarly numbered. However, FIG. 2C shows that the user has now input yet another allocation value of 30 percent, in field 182. The user has also identified a financial dimension that is to receive the 30 percent allocation as the “OU_{—}4562” ledger account which is the “sales (USA)” department. This is indicated in fields 156 and 160.

It can be seen in FIG. 2C that the total allocation indicator 178 now reads 100 percent. Therefore, in one embodiment, no further allocations or financial dimensions need to be identified by the user. Processing thus proceeds to block 184 in FIG. 2.

It should be noted that the user can take other actions as well, other than inputting an allocation or a financial dimension. For example, the user can edit any of the allocations by simply selecting a different field 150, 176 and 182 and either revising the percentage values stored therein, or by revising the corresponding financial dimension information in fields 156 and 160. Similarly, of course, the user can update the template ID 146 as well. If the user desires to take any of these actions, those actions are taken as indicated by block 186.

Otherwise, the user can store the newly generated allocation template in data store 110 (or another data store). It should be noted that the newly generated allocation template is not specifically tied to an account number or source document. Instead, it is simply a general allocation template that can be applied to a source document to assign certain percentages of the amounts in that source document to various financial dimensions. This is described below with respect to FIG. 3. Storing the newly created template is indicated by block 188 in FIG. 2.

Financial template component 108 then determines whether user 102 wishes to generate any more templates. This can be done, for example, by the user actuating the “new” button 190 on user interface display 180. If more templates are to be generated, then processing reverts back to block 140 in FIG. 2. If not, template generation is completed. Determining whether more templates are to be created is indicated by block 192 in FIG. 2.

It will be appreciated that the user interface displays shown in FIGS. 2A-2C are exemplary only. New allocation templates can be generated in other ways as well. For instance, FIG. 2D shows a user interface display 200 that can be used to generate a new allocation template.

User interface display 200 includes a template ID field 202 that includes various template identifiers 204. The user can input new template identifiers by simply typing them in, or by selecting them from a dropdown menu, or in any other desired way. Once the template identifier is input in field 202, it is also reflected in block 204. The user can then specify financial dimensions in financial dimension field 206. In the embodiment shown in FIG. 2D, the financial dimensions can be a “department” a “cost center” they can have a “purpose”, they can be allocated to a “fund” and the percent of allocation is also indicated. Therefore, in one embodiment, the user simply places the cursor in one of columns 208, 210, 212, 214 and 216 and enters the desired information. Of course, this can be input through a dropdown menu, through drag and drop functionality, or in any other desired way as well. In the embodiment shown in FIG. 2D, it can be seen that the administration department has been assigned 20 percent, the product department has been assigned 45 percent and the project department has been assigned 35 percent using the allocation template shown in user interface display 200.

FIG. 3 illustrates one embodiment of a flow diagram showing the operation of business system 100 in assigning an allocation template 121 to a source document, and then processing the source document based on the assigned allocation template. FIGS. 3A-1 to 3G show exemplary user interface displays that can be generated in assigning an allocation template 121 to a source document.

In order to assign an allocation template 121 to a source document, the user first selects a source document to be operated on. This is indicated by block 250 in FIG. 3. The source document can be any of the variety of source documents stored in business data store 110, or elsewhere. For instance, the source document can be a purchase order 116, sales order 118, invoice 114, or another source document 120.

FIGS. 3A-1 and 3A-2 show a set of user interface displays 252 and 254, respectively. In one embodiment, user interface display 254 in FIG. 3A-2 is displayed, on the same display, and underneath, user interface display 252 shown in FIG. 3A-1. However, for ease of reference, displays 252 and 254 have been enlarged and shown as two separate displays. However, they can be displayed together, with one over the top of the other, with one above or below the other, or otherwise.

In any case, user interface display 252 shows that user 102 has selected a purchase order 116 as the source document, such as by selecting purchase order tab 256. Then, by providing a suitable user input, the user illustratively views a drop down menu or list page or other mechanism which shows the various purchase orders 116 that can be selected, and the user simply selects one of the purchase orders to be operated on. In the example shown in FIG. 3A-1, the user has selected purchase order “000411:1001-ACME Co.”. User interface display 252 has a description display portion 260. Display portion 260 includes purchase order field 262, name field 264, purchase type selection field 266, and vendor description information 268. The description display portion 260 also includes a plurality of other display portions such as display portions showing contact information, status, storage dimensions, and other fields that can be populated.

User interface display portion 260 also includes a control bar 270 that includes controls. The control bar includes section 272 that has control 273 for creating a new purchase order and control 275 for creating one from a sales order. Control bar 270 also includes controls for performing maintenance on a purchase order, such as editing a purchase order using edit control 274 or requesting a change to a purchase order using change control 276. Control bar 270 also allows the user to change the view of the purchase order being displayed by selecting a header view using header view control 278 or a line view using line view control 280. A variety of other controls are provided as well.

FIG. 3A-1 shows that the user has chosen to edit the purchase order by selecting the edit control 274 and is viewing the purchase order using the header view, by selecting header view control 278.

After the user has selected a source document (such as the purchase order shown in FIG. 3A-1), the user can then assign an allocation template 121 to the source document (e.g., to the purchase order). This is indicated by block 282 in FIG. 3. The user can do this in a number of different ways.

For instance, it may be that a purchase order 116 has a plurality of different lines, each associated with a given amount. For instance, if the purchase order shown in FIG. 3A-1 is a purchase order for two automobiles, one being a regular automobile and the other being a truck, each of those items purchased will have a purchase amount associated with them. The user may wish to allocate the cost of the regular automobile to a given subset of financial dimensions. However, the user may wish to allocate the cost associated with the truck to a different subset of financial dimensions. By way of example, the ACME Co. may have a sales workforce and a maintenance workforce. The sales workforce might drive cars, while the maintenance workforce drives trucks. Thus, it may be that when the company purchases a car (or a normal size vehicle), that cost is allocated to the various portions of the company in a different way than when the company purchases a truck. In that case, the user may wish to assign a different allocation template 121 to each of the lines in the purchase order. That is, if one line represents the purchase of a car, the user may wish to assign a given allocation template to that line of the purchase order. If the second line of the purchase order represents the purchase of a truck, the user may wish to assign a different allocation template to that line of the purchase order. In one embodiment, the user can assign separate allocation templates to each line of the purchase order. This is indicated by block 284 in FIG. 3.

However, it may also be that the user wishes to assign the same allocation template to every line in the purchase order. This can also be done in a number of different ways. In one embodiment, the user can simply select each line individually and assign the same allocation template to each line. Alternatively, however, the system provides an embodiment in which the user can assign an allocation template at the header level of the source document (such as at the header level of the purchase order) and that allocation template will then automatically be applied to every line of the purchase order. For instance, it may be that the purchase order shown in FIG. 3A-1 has multiple different lines, but they are all for truck purchases. In that case, the user may wish to assign the same allocation template to each line in the purchase order. Therefore, in accordance with one embodiment, the user simply assigns that allocation template to the header of the purchase order, and the same allocation template is automatically assigned to each line in the purchase order. Assigning an allocation template at the header level of the source document is indicated by block 286 in FIG. 3.

Of course, the user may assign allocation templates in different ways as well. By way of example, it may be that the user can group the lines of a purchase order into various groups, and assign each group an allocation template which will automatically be applied to each line in that group. Assigning allocation templates in other ways is indicated by block 288 in FIG. 3.

The user interface display 254 shown in FIG. 3A-2 illustrates one way of assigning an allocation template at the header level of the source document. Recall that in FIG. 3A-1, the user has selected the header view by actuating header view control 278 for the source document (for the purchase order 000411:1001-ACME Co.). While the user is viewing the purchase order in the header view, the user selects the financial dimensions control 290 shown in FIG. 3A-2. This expands the financial dimensions view to show template ID selector 292, and financial dimension selectors 294. In the embodiment shown in FIG. 3A-2, the financial dimension selectors include a branch selector 296 and a department selector 298.

FIG. 3A-2 shows that the user has actuated a drop down menu button 300 on the template ID selector 292 which then displays a drop down menu 302. The drop down menu 302 contains a list of template IDs for previously created allocation templates 121 which can be assigned at the header level of the source document represented by user interface display 252 shown in FIG. 3A-1. It can be seen that the user has selected the “Vehicle” template ID and it now appears in template selector 292. The user can fill in additional financial dimensions using selectors 296 and 298, as indicated by block 349 in FIG. 3. In one embodiment, selectors 296 and 298 also include drop down menu actuators which can be actuated by the user to see a drop down menu of selectable financial dimensions. The financial dimensions of the allocation template with the template ID “Vehicle” will automatically be assigned at the header level of the source document (the purchase order shown in FIG. 3A-1). Therefore, the “Vehicle” allocation template will be applied to each line in the purchase order so that the cost associated with each line in the purchase order will be allocated to the various financial dimensions, in the percentages defined, in the “Vehicle” allocation template.

FIG. 3B shows a user interface display 304 that has some similarities to the user interface displays shown above in FIGS. 3A-1 and 3A-2, and similar items are similarly numbered. However, it can be seen in FIG. 3B that the user has now chosen to see the line view of the source document by actuating the line view control 280. User interface display 304 shows that the underlying source document (the selected purchase order) has one line 306 that reflects the purchase of one automobile for $1300.00

User interface display 304 also illustratively includes a plurality of selectable tabs 308 which can be selected to view different data associated with the source document (i.e., associated with the purchase order). In the embodiment shown in FIG. 3B, the user has selected the financial dimension tab 310. Therefore, financial dimension field 312 is expanded to show the allocation template assigned to the highlighted line (e.g., line 306), along with the particular financial dimensions corresponding to that allocation template. It can be seen that the user has selected line 306 (by the fact that it is the only line in the purchase order), and template selector 292 shows that the “Vehicle” allocation template has been assigned to the selected line 306. Recall that this assignment may have been made in different ways. For instance, the user may have assigned the “Vehicle” allocation template to this individual line 306 of the purchase order, or the user may have assigned the “Vehicle” allocation template to the header of this purchase order, in which case it is automatically applied to every line in the purchase order. In any case, it can be seen that when the user selects line 306 and the financial dimension tab 310, selector 292 shows that the “Vehicle” allocation template has been assigned to line 306 in this purchase order.

FIG. 3C shows another user interface display 320. User interface display 320 is similar, in some ways, to user interface display 304 shown in FIG. 3B, and similar items are similarly numbered. However, FIG. 3C also shows that user interface display 320 has a pop-up display 322 which specifically indicates the accounting distributions made by applying the “Vehicle” allocation template to line 306 in the present purchase order. The user can generate pop-up display 322 in a variety of different ways. For instance, by clicking on a given user input mechanism, such as a “Distribute Amount” button, this may allow the user to generate display 322. Of course, display 322 can be generated in other ways as well.

In any case, display 322 shows the accounting distributions (e.g., the percentage allocations) that are made by applying the “Vehicle” allocation template to the cost amount in line 306 of the purchase order. It can be seen that display 322 illustratively includes an instruction portion 324 that provides, in the illustrated embodiment, textual instructions. In addition, it can be seen that display 322 includes a hierarchical field 326 that shows the specific purchase order line that the allocation template is being applied to. Also, display 322 illustratively includes a “distributed by” field 328. In one embodiment, field 328 includes a drop down menu button 330 which can be selected by the user to change how the distributions are made. In the embodiment shown in FIG. 3C, the distributions corresponding to the “Vehicle” allocation template are made by percentage. As discussed above with respect to FIG. 2A, they could be made in other ways, such as by dollar amount, or in other ways.

Display 322 also includes an allocation field 332 that shows specifically how the cost in line 306 of the purchase order is allocated. Allocation field 332 illustratively includes a number field 334 which shows the number of different allocations that are being made using this allocation template. Ledger account field 336 shows the actual financial dimension (ledger account number) that is receiving the allocation. Percent field 338 shows the percent of the total cost (in this case the percent of $1300) that is being assigned to each ledger account and amount field 340 shows the amount when that percentage is applied against the overall cost. In one embodiment, display 322 also includes an accounting event field 342 which can list accounting events associated with this allocation, and an accounting date field 344 which indicates when this allocation is effective, from an accounting standpoint.

It can be seen that the “Vehicle” allocation template being applied to line 306 in the purchase order (and displayed in allocation field 332) is the same allocation template that was created above with respect to the discussion of FIGS. 2A-2C. Therefore, the “Vehicle” allocation template assigns 30 percent of the cost of the Vehicle to ledger account OU_{—}4562; 60 percent of the cost to ledger account OU_{—}115; and 10 percent of the cost to ledger account OU_{—}1. It can thus be seen that once an allocation template 121 is assigned to a given line of a source document, the specified template automatically allocates the amount in that line of the source document as specified when the allocation template was generated. It can also be seen that the Branch value defaulted to the MSP Branch from the financial dimensions under the template (e.g., on the header or lines of the purchase order) because the Branch did not have a default value specified during setup of the template (as shown in FIGS. 2A-2D). Automatically assigning the allocations across the identified financial dimensions is indicated by block 350 in FIG. 3.

FIGS. 3D and 3E show two exemplary user interface displays that can be generated when the underlying source document (e.g., the purchase order) has multiple lines and the same allocation template is assigned to each of those lines. Again, recall that the same allocation template can be assigned to multiple different lines of an underlying source document by manually selecting each individual line and assigning the same allocation template, or by simply assigning the allocation template at the header level of the source document.

In any case, FIG. 3D shows user interface display 352. User interface display 352 is similar to user interface display 304 shown in FIG. 3B and similar items are similarly numbered. However, it can be seen that the underlying source document (the purchase order 000411:1001-ACME Co.) now not only has line 306 associated with the purchase of an automobile, but it also has a second line 354 which reflects the purchase of truck. Line 354 shows that one truck is purchased at the price of $1400. It can also be seen that the user has selected line 354 on the source document.

In the embodiment shown in FIG. 3D, the screen displaying user interface display 352 is a touch sensitive screen, and the user has used his or her finger 351 to select line 354. Of course, selection can be made in a wide variety of other ways, depending upon the user input mechanisms available to the user. For instance, the user can select line 354 using a point and click device, using a keyboard, using a stylus, using other touch gestures, or even using voice commands. In any case, once the user has selected line 354 and selected the financial dimension tab 310, financial dimensions display field 312 shows that the “Vehicle” allocation template has been assigned to line 354.

FIG. 3E shows user interface display 355 which is similar to user interface display 320 shown in FIG. 3C, and similar items are similarly numbered. However, FIG. 3E shows that pop-up menu 356 now shows the specific allocations made to line 354 in the underlying source document, instead of to line 306 (as was shown in FIG. 3C). Thus, in the example shown in FIG. 3E, the specific allocations made to specified ledger accounts are shown both by percent and by amount in pop-up menu 356, as they were in pop-up menu 322 of FIG. 3C.

FIGS. 3F and 3G show user interface displays that can be generated when a different allocation template has been assigned to each line in the underlying source document. FIG. 3F show user interface display 400 which is similar to user interface display 352 shown in FIG. 3D, and similar items are similarly numbered. However, it can be seen in FIG. 3F that the user has selected line 354 in the purchase order and has also selected financial dimension tab 310. Thus, financial dimension display field 312 again displays the allocation template that is assigned to line 354. Instead of the “Vehicle” allocation template that is shown in FIG. 3D, FIG. 3F shows that a different template (with the template ID “Large Vehicle”) has been assigned to line 354 in the underlying source document. If the user were to select line 306 in the purchase order, then financial dimensions display field 312 would show that the “Vehicle” allocation template is assigned to line 306. However, because the user has selected line 354, field 312 shows that a different template (the “Large Vehicle” template) has been assigned to line 354. FIG. 3G shows a user interface display 402 which is similar to user interface display 355 shown in FIG. 3E. However, user interface display 402 now shows that pop-up display 404 shows the details generated by applying the “Large Vehicle” allocation template to line 354 in the purchase order. As shown in the allocation display field 332, the “Large Vehicle” allocation template assigns 50 percent of the cost to ledger account No. 01234567 and the other 50 percent to ledger account No. 76543210.

From the above discussion, it can thus be seen that once an allocation template is assigned to an amount in a source document, the financial application 112 applies the template to the document so that the amount in the source document is allocated as defined by the allocation template. This is indicated by block 420 in FIG. 3.

Financial application 112 then processes the underlying source document using the template allocations applied from the allocation template or templates assigned to the source document. This is indicated by block 422 in FIG. 3. By way of example, application 112 can post the allocations to the ledger accounts. This is indicated by block 424. Alternatively, or in addition, application 112 can send notifications to various departments that the allocation has been made, as indicated by block 426. Of course, application 112 can perform other processing when the source document is processed using the allocation templates assigned to it. This is indicated by block 428. Finally, the source document with the applications applied to it are stored in business data store 110 for any desired later processing. This is indicated by block 430 in FIG. 3.

It can be seen that the user 102 can basically create any desired number of allocation templates using financial template component 108, and store them in data store 110 (or elsewhere) for later use. In the embodiments discussed herein, the allocation templates 121 are not assigned to, or otherwise tied to, a main account. Therefore, they can be applied across different accounts, as desired by the user. In addition, the user can create an allocation template 121 that allocates across a combination of substantially any financial dimensions and financial dimension values. For example, one percentage may be allocated to a cost center financial dimension, but another percentage in the same template may be allocated to a department financial dimension. Thus, the allocation templates 121 can be used to assign allocations to all different financial dimensions. Similarly, user 102 can delete an allocation template 121 from data store 110, at any time. Even if one of those allocation templates 121 has already been assigned to a source document, the source document will not be affected because it is only the template that is being deleted. Because the source document has already had the template applied to it and stored, deleting the underlying allocation template 121 does not affect the source document. Further, in one embodiment, the allocation templates 121 are illustratively automatically updated by financial template component 108, with any new dimensions that may be added to the chart of accounts. Therefore, when new templates are created, the user can select from all of the available financial dimensions that are currently being used by financial application 112. Further, the allocation templates 121 can be named using any identifier provided by the user. The name does not imply where the allocation template 121 can be used, but it is merely an identifier.

It will be appreciated that, while FIG. 1 shows business system 100 with certain elements, such as components, data stores and applications, the functionality of those elements can be combined into fewer elements or distributed into more elements. For instance, application 112 can include financial template component 108 as but one example. Similarly, the elements can be distributed or deployed in different architectures. The elements, or portions of them, can reside on a user device or a server. The functionality can be deployed in a wide variety of different ways.

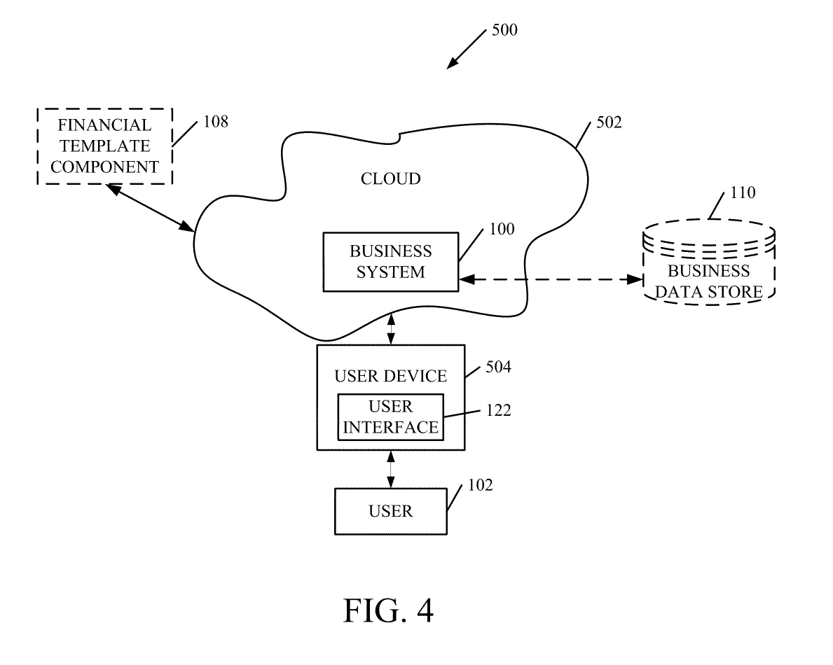

FIG. 4 is a block diagram of system 100, shown in FIG. 1, except that it is disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that business system 100 is located in cloud 502 (which can be public, private, or a combination where portions are public while others are private). Therefore, user 102 uses a user device 504 to access those systems through cloud 502.

FIG. 4 also depicts another embodiment of a cloud architecture. FIG. 4 shows that it is also contemplated that some elements of business system 100 are disposed in cloud 502 while others are not. By way of example, data store 110 can be disposed outside of cloud 502, and accessed through cloud 502. In another embodiment, financial template component 108 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

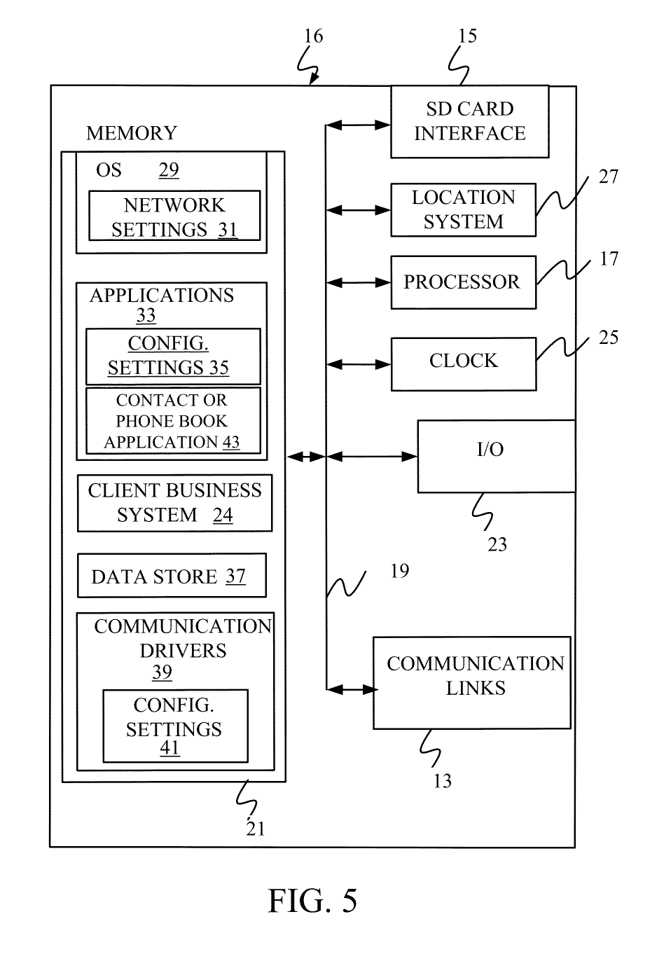

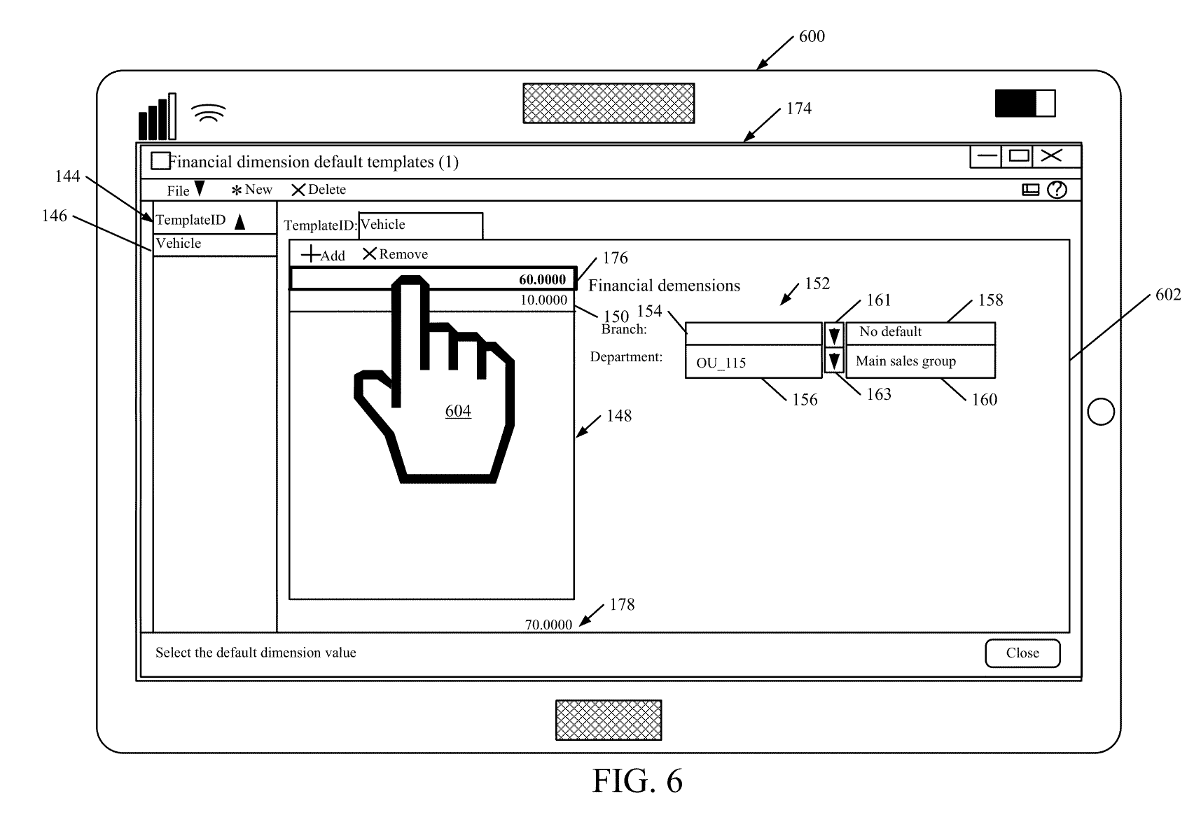

FIG. 5 is a simplified block diagram of one illustrative embodiment of a handheld or mobile computing device that can be used as a user's or client's hand held device 16, in which the present system (or parts of it) can be deployed. FIGS. 6-9 are examples of handheld or mobile devices.

FIG. 5 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processors 104 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data store 110, for example, can reside in memory 21. Similarly, device 16 can have a client business system 24 which can run various business applications or embody parts or all of business system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

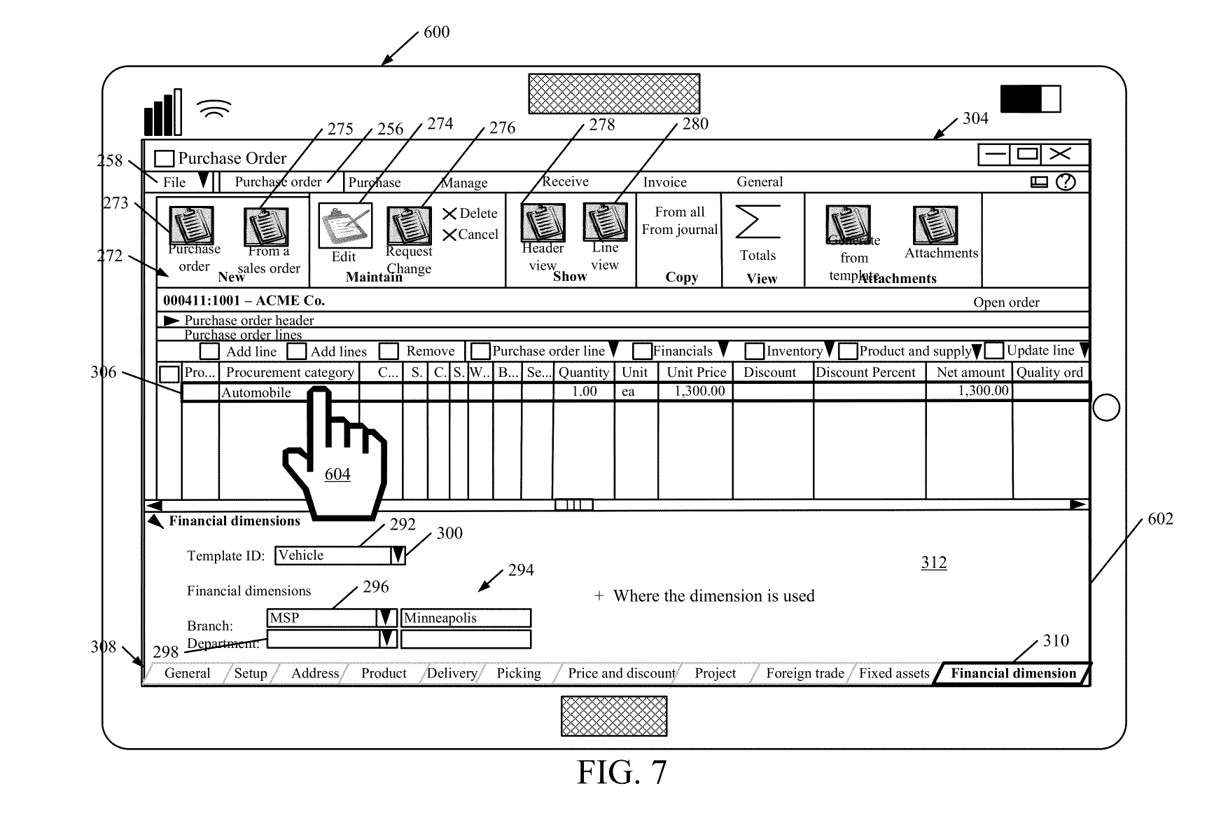

FIGS. 6 and 7 show one embodiment in which device 16 is a table computer 600. In FIG. 6, computer 600 is shown with user interface display 174 (used to generate an allocation template 121) displayed on the display screen 602. FIG. 7 shows computer 600 with user interface display 304 (used to apply an allocation template 121 to a source document) displayed on display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

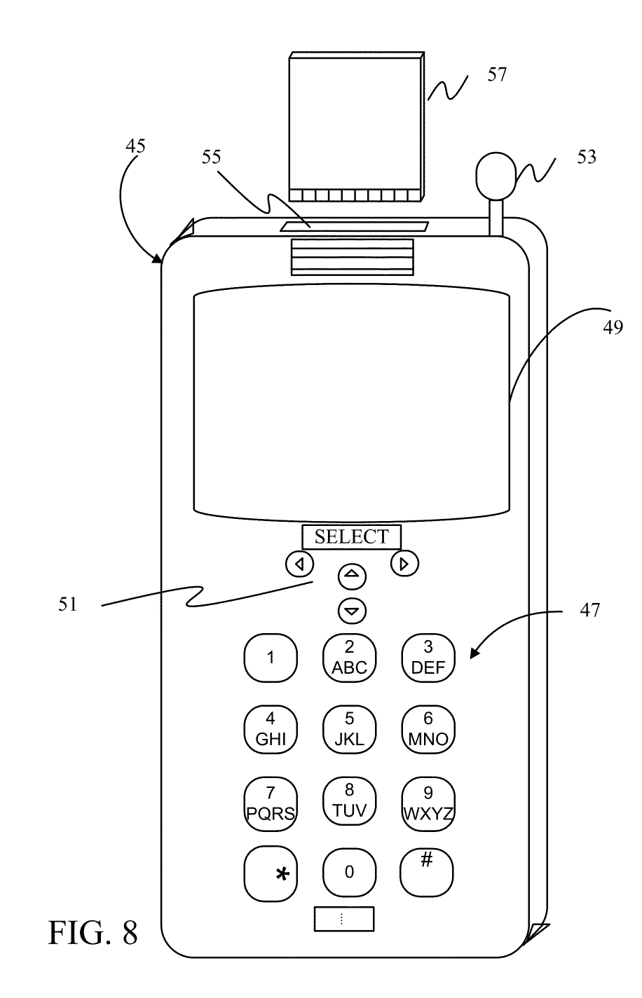

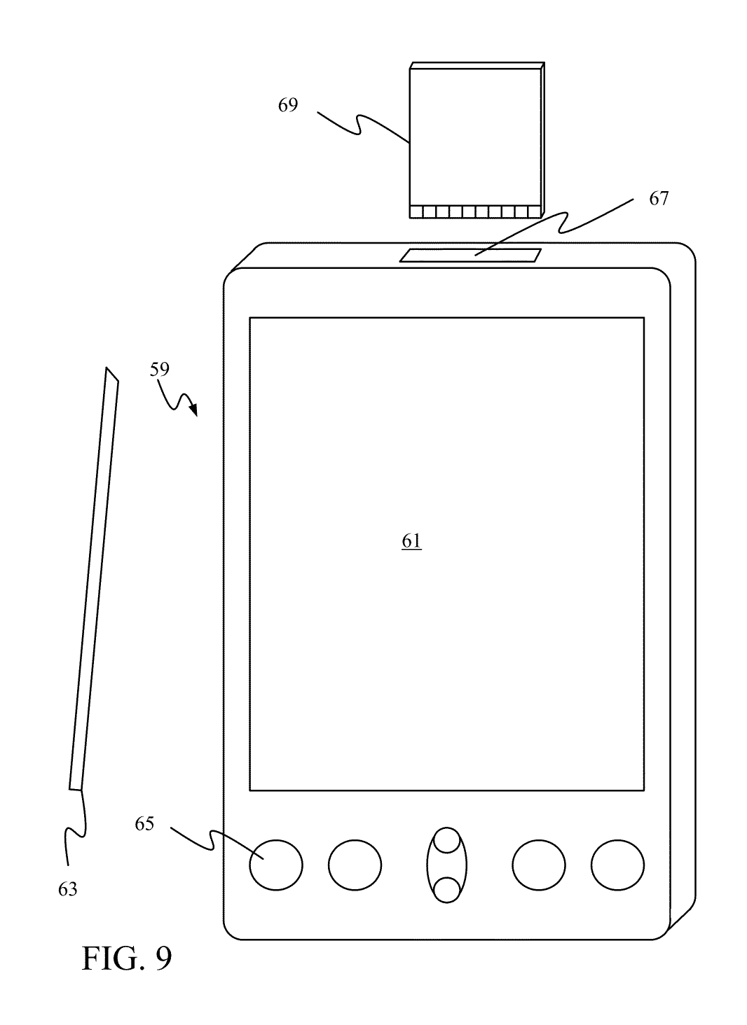

FIGS. 8 and 9 provide additional examples of devices 16 that can be used, although others can be used as well. In FIG. 8, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1×rtt, and Short Message Service (SMS) signals. In some embodiments, phone 45 also includes a Secure Digital (SD) card slot 55 that accepts a SD card 57.

The mobile device of FIG. 9 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible.

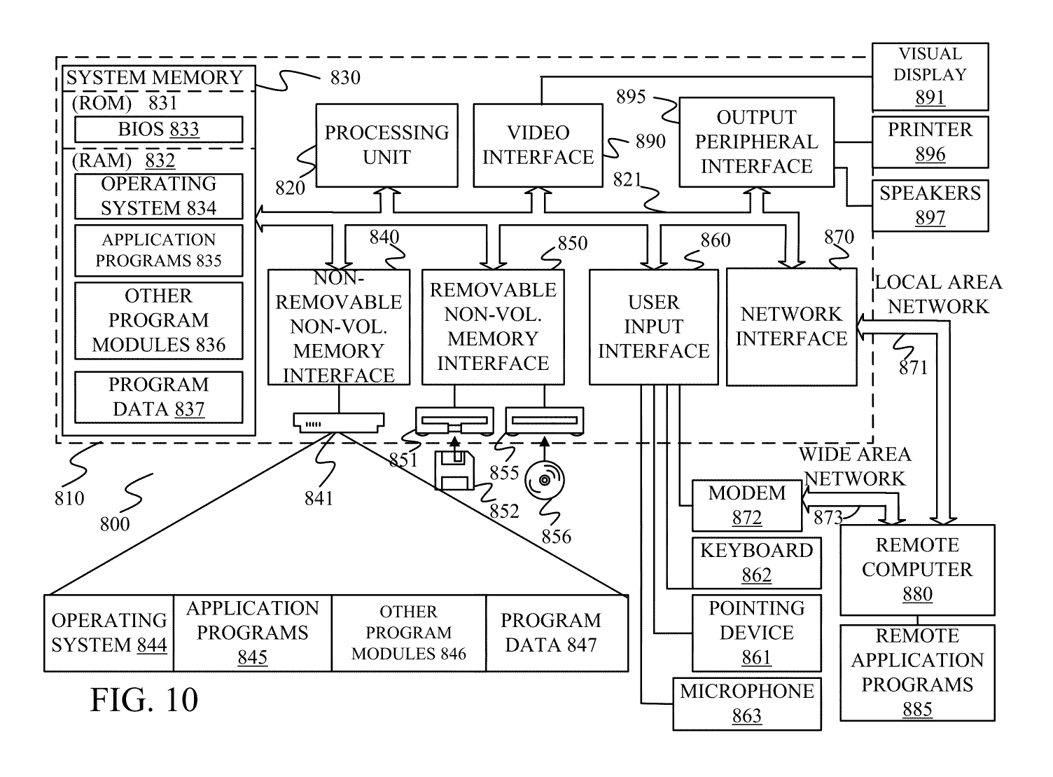

FIG. 10 is one embodiment of a computing environment in which system 100 (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 104), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of allocating an amount in a source document, comprising:
displaying an allocation template form with an allocation input field and a financial dimension input field, along with a user input mechanism that receives user inputs;
receiving user inputs comprising an allocation input indicative of an allocation amount, in the allocation input field, and a financial dimension input indicative of a financial dimension, in the financial dimension input field, to receive an allocation indicated by the allocation amount;
repeating the step of receiving an allocation input and a financial dimension input until the allocation amounts total a total allocation value; and
storing the allocation template form with the allocation amounts and the financial dimensions, as an allocation template, that is assignable to any of a plurality of different source documents to allocate underlying amounts in the source documents as indicated by the allocation amounts and the financial dimensions in the allocation template.

2. The computer-implemented method of claim 1 and further comprising:
repeating the steps of displaying an allocation template form, receiving user inputs, repeating the step of receiving an allocation input and a financial dimension input, and storing the allocation template form with the allocation amounts and the financial dimensions, to obtain a data store of a plurality of different allocation templates.

3. The computer-implemented method of claim 2 and further comprising:
receiving a selection of one of the plurality of different source documents to obtain a selected source document; and
receiving a selection of a template identifier identifying one of the plurality of different allocation templates to be assigned to the selected source document.

4. The computer-implemented method of claim 3 and further comprising:
automatically allocating portions of an amount in the selected source document to financial dimensions indicated in the selected allocation template based on the allocation amounts in the selected allocation template.

5. The computer-implemented method of claim 4 wherein the selected source document includes a plurality of lines, each line having a corresponding amount to be allocated, and further comprising:
receiving an assignment input assigning the selected allocation template to one or more of the plurality of lines in the source document; and
automatically allocating the amount corresponding to the one or more lines to financial dimensions indicated in the selected allocation template based on the allocation amounts in the selected allocation template.

6. The computer-implemented method of claim 5 wherein receiving an assignment input assigning the selected allocation template to one or more lines, comprises:
receiving a separate assignment input assigning the selected allocation template to each of the one or more lines in the selected source document.

7. The computer-implemented method of claim 5 wherein receiving an assignment input assigning the selected allocation template to one or more lines, comprises:
receiving a whole document assignment input assigning the selected allocation template to all of the plurality of lines in the selected source document; and
automatically allocating the amount corresponding to each of the plurality of lines to financial dimensions indicated in the selected allocation template based on the allocation amounts in the selected allocation template.

8. The computer-implemented method of claim 7 wherein receiving a whole document assignment input comprises:
displaying the selected source document, including a header of the source document;
receiving a header assignment input assigning the selected allocation template to the header of the source document; and
automatically assigning the selected allocation template to each of the plurality of lines in the selected source document, based on the header assignment input.

9. The computer-implemented method of claim 5 wherein receiving an assignment input comprises:
receiving an assignment input assigning the selected allocation template to a first of the plurality of lines in the source document;
receiving a selection of a second template identifier identifying a second of the different allocation templates; and
receiving a second assignment input assigning the second allocation template to a second of the plurality of lines in the source document.

10. The computer-implemented method of claim 9 and further comprising:
automatically allocating the amount corresponding to the first line in the source document to financial dimensions indicated in the selected allocation template assigned to the first line based on the allocation amounts in the selected allocation template assigned to the first line; and
automatically allocating the amount corresponding to the second line in the source document to financial dimensions indicated in the second allocation template assigned to the second line based on the allocation amounts in the second allocation template assigned to the second line.

11. The computer-implemented method of claim 3 wherein receiving a selection of one of the different source documents comprises:
receiving selection of one of a sales order, a purchase order and an invoice.

12. The computer-implemented method of claim 4 and further comprising:
automatically posting the portions of the amount allocated to the financial dimensions to ledger accounts corresponding to the financial dimensions.

13. The computer-implemented method of claim 5 wherein storing the allocation template comprises storing the allocation template in a data store of allocation templates and further comprising:
deleting the selected allocation template from the allocation store without changing allocations made to the selected source document that has the selected allocation template assigned to it.

14. The computer-implemented method of claim 1 wherein storing the allocation form as an allocation template that is assignable to any of a plurality of different source documents, comprises:
storing the allocation template without tying it to a specific account in a business system.

15. The computer-implemented method of claim 1 wherein receiving a financial dimension input comprises:
receiving a plurality of financial dimension inputs, one corresponding to each allocation input, the plurality of financial dimension inputs identifying different types of financial dimensions.

16. The computer-implemented method of claim 15 wherein the different types of financial dimensions comprise a cost center and a department.

17. A business system, comprising:
a financial template component that generates a template generation user interface that receives template generation inputs that generate a plurality of different allocation templates, each of the allocation templates allocating portions, of an amount reflected in a source document, to corresponding financial dimensions, the portions and corresponding financial dimensions being received as the template generation inputs, the financial template component storing the allocation templates for assignment to a source document; and
a computer processor, being a functional part of the business system and activated by the financial template component to facilitate generating the allocation templates.

18. The business system of claim 17 wherein the financial template component generates an assignment user interface that receives a source document selection input selecting one of a plurality of different source documents and a template identifier input identifying one of the plurality of allocation templates assigned to the selected source document, the financial template component automatically allocating the portions of the amount reflected in the selected source document to the corresponding financial dimensions as indicated in the allocation template assigned to the selected source document.

19. The business system of claim 18 wherein the assignment user interface comprises:
a header assignment mechanism that receives an assignment input assigning a selected allocation template to a header of the selected source document so the selected allocation template is assigned to each of a plurality of lines in the selected source document; and
a line assignment mechanism that receives an assignment input assigning a selected allocation template to a line of the selected source document.

20. A computer readable medium storing computer readable instructions which, when executed by a computer, cause the computer to perform a method, comprising:
displaying an allocation template assignment interface;
receiving a selection of one of a plurality of different source documents, reflecting an amount to be allocated, to obtain a selected source document;
receiving a selection of a template identifier identifying one of a plurality of different allocation templates to be assigned to the selected source document, the identified allocation template having a plurality of allocation input fields each indicative of an allocation amount, and a plurality of financial dimension input fields, each corresponding to an allocation input field and being indicative of a financial dimension to receive an allocation indicated by the allocation amount in the corresponding allocation input field;
receiving an assignment input assigning the identified allocation template to the selected source document; and
automatically allocating the amount reflected in the selected source document to the financial documents in the identified allocation template based on the allocation amounts in the corresponding allocation input fields of the identified allocation template.
